(19) United States
(12) Patent Application Publication
(10) Pub. No.: US 2006/0266422 A1
(43) Pub. Date: Nov. 30, 2006

(54) Check valve with an improved clapper and valve seat

(76) Inventors: Shawn J. Feenstra, Caledonia, MI (US); Eldon D. Jackson, Hastings, MI (US); Vinh B. Hoa, Kentwood, MI (US)

Correspondence Address: VAN DYKE, GARDNER, LINN AND BURKHART, LLP, 2851 CHARLEVOIX DRIVE, S.E., P.O. BOX 888695, GRAND RAPIDS, MI, 49588-8695, US

(21) Appl. No.: 11/407,784

(22) Filed: Apr. 20, 2006

Related U.S. Application Data
(60) Provisional application No. 60/684,904, filed on May 26, 2005.

(51) Int. Cl. F16K 15/03

(52) U.S. Cl. 137/527

(57) ABSTRACT

A check valve includes a valve body, a valve seat positioned in the passageway of the valve body dividing the passageway into two chambers and a clapper assembly, which is pivotally mounted to the valve seat. The valve seat has a valve seat body and an opening through said valve seat body. The clapper assembly is pivotally mounted to the valve seat by a hinge pin and biased to close the opening of the valve seat body to thereby block the flow of fluid through said passageway. Further, the hinge pin is captured between portions of the valve body to thereby retain the clapper assembly at the valve seat.

This application claims priority from U.S. provisional application Ser. No. 60/684,904, filed May 26, 2005, entitled CHECK VALVE WITH AN IMPROVED CLAPPER AND VALVE SEAT, by Applicants Shawn J. Feenstra, Eldon D. Jackson, and Vinh B. Hoa, and is incorporated by reference herein in its entirety.

### TECHNICAL FIELD AND BACKGROUND OF THE INVENTION

The present invention relates to a check valve and, more particularly, to a check valve with an improved clapper and valve seat.

### SUMMARY OF THE INVENTION

The present invention provides an improved check valve that facilitates the installation, repair or replacement of the clapper assembly and/or any of the seals, or of the valve seat.

Accordingly, in one form of the invention, a check valve includes a valve body, with a passageway therethrough, a valve seat positioned in the valve body in the passageway dividing the passageway into two chambers, and a clapper assembly. The valve seat has a valve seat body and an opening through the valve seat body. The clapper assembly is pivotally mounted to the valve seat by a hinge pin and is biased to close the opening of the valve seat body to thereby block the flow of fluid through the passageway. The hinge pin is captured between the valve body to thereby retain the clapper assembly at the valve seat.

In another form of the invention, a check valve includes a valve body with a passageway therethrough, a valve seat positioned in the valve body in the passageway dividing the passageway into two chambers, and a clapper assembly. The valve seat includes a valve seat body, with an opening through the valve seat body, and a pair of flanges, which are interconnected by a transverse member. The clapper assembly is pivotally mounted the valve seat by a hinge pin, which includes a torsion spring that biases the clapper assembly to close the opening of the valve seat body to thereby block the flow of fluid through the passageway. The spring applies a spring force against the clapper assembly and also against the valve seat.

In yet another form of the invention, a check valve includes a valve body with a passageway therethrough, which forms an inlet and an outlet for the valve body, and a clapper and valve seat assembly, which is positioned in the valve body in the passageway to divide the passageway into two chambers. The clapper and valve seat assembly has a valve seat and a clapper assembly pivotally mounted the valve seat by a hinge pin. The clapper assembly is biased in a closed position to seal against the valve seat to thereby block the flow of fluid through the passageway. In addition, the outlet of the valve body is dimensioned to permit the clapper and valve seat assembly to be inserted through the outlet for installation in the valve body.

In any one of these inventions, the clapper assembly typically includes a base member with at least one resilient face for sealing against the valve seat. For example, the base member may be at least partially encapsulated with a resilient material, with the resilient material forming the at least one resilient face.

In another form of the invention, a check valve includes a valve body, with a passageway therethrough, a valve seat positioned in the valve body in the passageway dividing the passageway into two chambers, and a clapper assembly. The valve seat has a valve seat body and an opening through the valve seat body. The clapper assembly is pivotally mounted the valve seat by a hinge pin and is biased to close the opening of the valve seat body to thereby block the flow of fluid through the passageway. The clapper assembly includes a base member, a resilient member with a rib, and a retainer securing the resilient member to the base member. The retainer has a recess for receiving the rib of the resilient member to thereby interlock the resilient member to the retainer and secure the resilient member to the base member.

In one aspect, the base member comprises a plate.

In another aspect, the rib comprises an annular rib. In addition, the resilient member typically comprises an annular resilient member.

In any of the above described inventions, the clapper assembly may include a pair of brackets, with each of the brackets including an elongate opening. The hinge pin extends through the elongate openings to thereby pivotally mount the clapper assembly to the valve seat. The elongated openings allow adjustment of the clapper assembly with respect to the valve seat in one direction but limit movement of the clapper with respect to the valve seat in another direction.

In other aspects, any of the valve seat bodies may comprise a plastic material. Optionally, any one of the valve seat bodies may be adhesively bonded to the valve body to thereby seal the valve seat in the passageway of the valve body.

In another aspect of any of these inventions, the valve seat body may be sealed in the valve body by a seal.

In further aspects of any of the inventions, the valve seat may include a pair of flanges, with the clapper assembly pivotally mounted to the flanges to thereby pivotally mount the clapper assembly to the valve seat. In addition, the valve typically includes a spring, which biases the clapper assembly to the closed position. For example, the spring may have a first end applying a spring force to the clapper assembly and a second end applying a spring force to valve body or the valve seat. In one aspect, the second end applies a spring force to the valve seat. In addition, the flanges of the valve seat may be interconnected by a transverse member, with the second end of the spring applying a spring force to the transverse member.

According to other aspects, any one of the valve seats may include at least one surface for an elastomeric seal or for an epoxy seal to seal against the valve body. In some applications, it may be preferably that the valve seat includes just an epoxy seal to seal against the valve body.

In any of the inventions, the valve seat may include a snap fitting coupling with the valve body.

Accordingly, the present invention provides a clapper and valve seat assembly that can be preassembled prior to being installed in the valve body. In addition, with the present construction, servicing of any of the clapper and valve seat assembly's components is facilitated.

These and other objects, advantages, purposes, and features of the invention will become more apparent from the study of the following description taken in conjunction with the drawings.

### DETAILED DESCRIPTION OF DRAWINGS

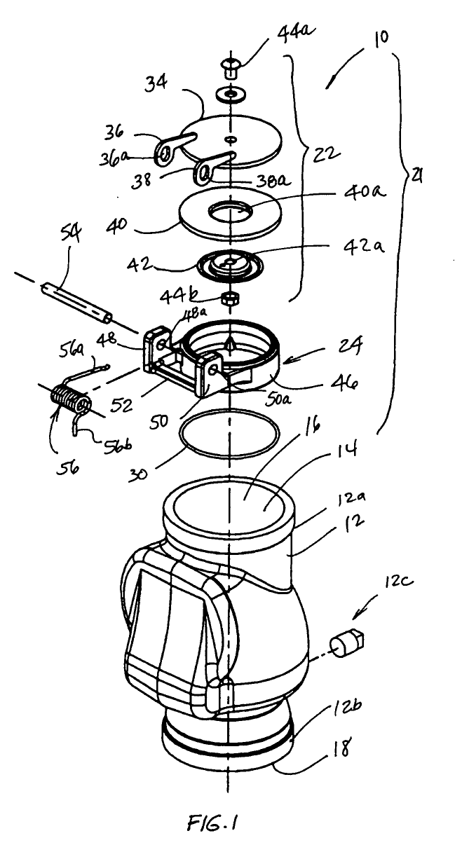

FIG. 1 is an exploded perspective view of a first embodiment of the check valve of the present invention;

FIG. 1A is a cut-away view of the valve of FIG. 1 illustrating the clapper and valve seat assembly;

FIG. 1B is an enlarged view of detail A of FIG. 1A;

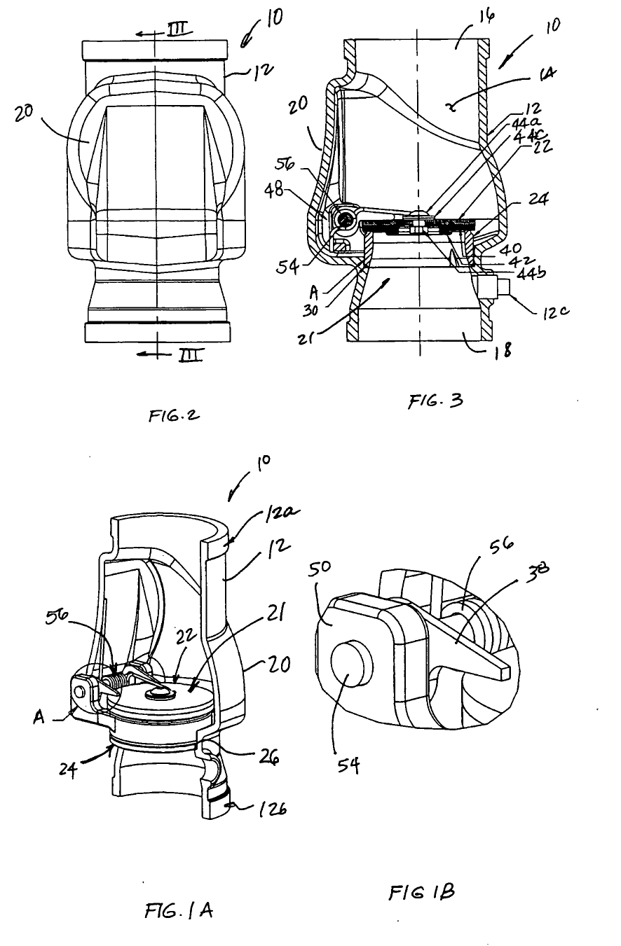

FIG. 2 is an elevation view of the check valve of FIG. 1;

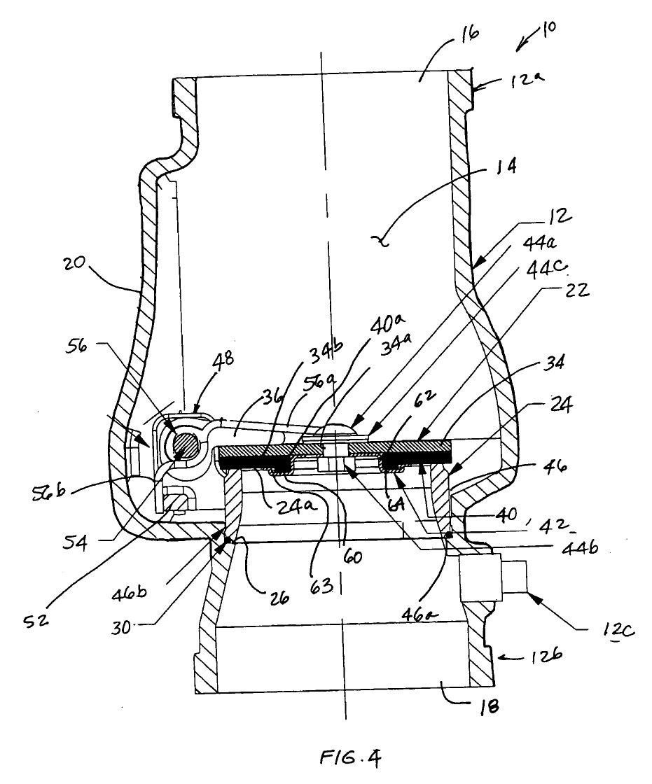

FIG. 3 is a cross-section view taken along line III-III of FIG. 2;

FIG. 4 is an enlarged view similar to FIG. 3;

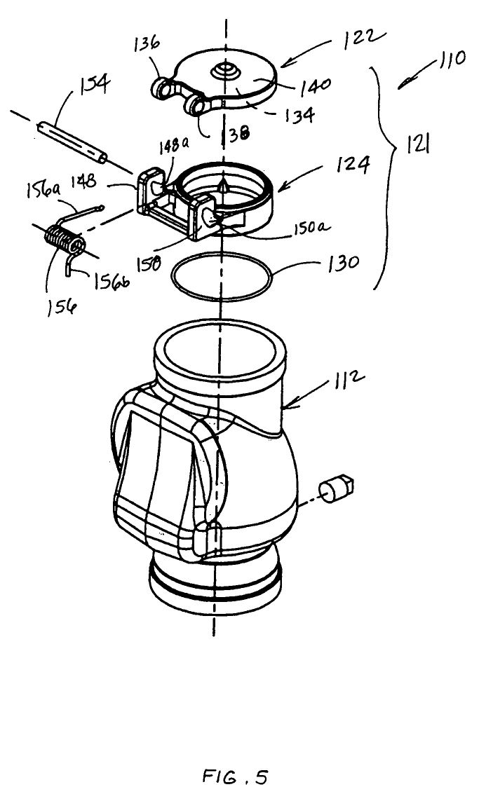

FIG. 5 is an exploded perspective view of a second embodiment of the check valve of the present invention;

FIG. 5A is a cut-away view of the valve of FIG. 5 illustrating another embodiment of the clapper and valve seat assembly of the present invention;

FIG. 5B is an enlarged view of detail B of FIG. 5A;

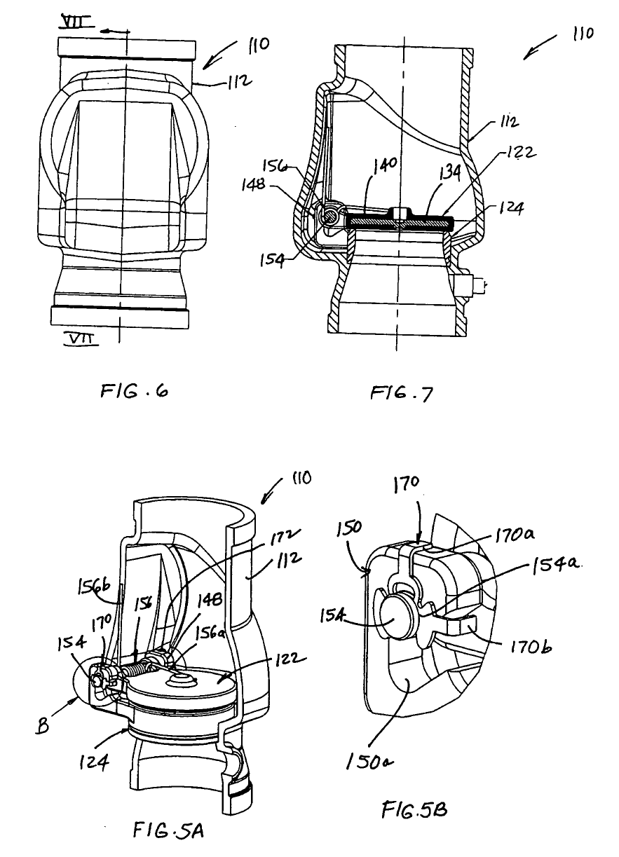

FIG. 6 is an elevation view of the check valve of FIG. 5;

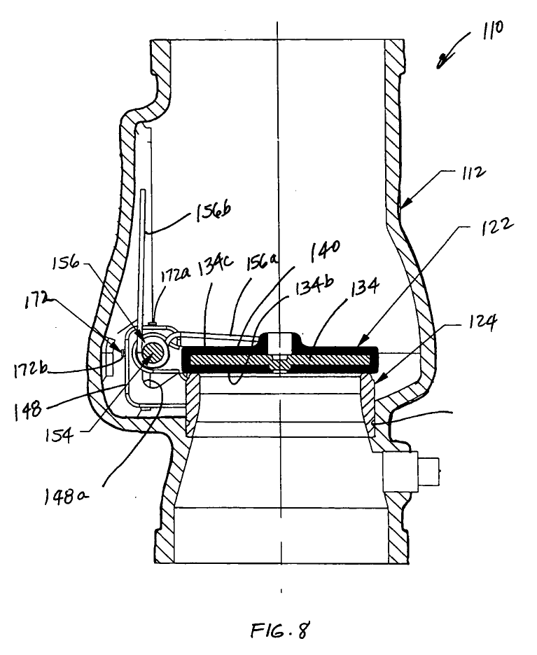

FIG. 7 is a cross-section view taken along line VII-VII of FIG. 6; and

FIG. 8 is an enlarged view of FIG. 7.

### DETAILED DESCRIPTION OF PREFERRED EMBODIMENTS

Referring to FIG. 1, the numeral 10 generally designates a check valve of the present invention. As will be more fully described below, check valve 10 includes an improved clapper and valve seat assembly that facilitates installation, removal, and/or repair the clapper and valve seat assembly and/or of its components. As will be more fully described below, with the construction of the clapper and valve seat assembly, the assembly may be preassembled as a modular unit. Further, the valve body is preferably configured so that the assembly may be installed through the outlet of the valve body, which further facilitates installation and repair or replacement of the assembly.

As best seen in FIGS. 1, 2, and 3, check valve 10 includes a valve body 12 with a transverse passage 14 that forms an inlet 18 and an outlet 16. Body 12 typically comprises a cast body, such as a cast iron or brass body, which when formed is formed with an enlarged portion 20 where a clapper and valve seat assembly 21 is located. As best seen in FIG. 4, enlarged portion 20 forms a pocket and a positive stop to receive clapper and valve seat assembly 21. In addition, body 12 may include end connections 12a, 12b, such as collars or annular ribs, that provide sealing surfaces and positive stops for split ring groove couplings. Further, body 12 typically includes a tapped and plugged hole (12c) for draining residual fluid in the inlet of the valve.

As best seen in FIGS. 1A and 4, body 12 is also formed with an inner annular ledge 26 below enlarged portion 20 to provide the positive stop on which clapper and valve seat assembly 21 rests and, further, optionally provides a surface for a seal 30, such as an o-ring seal, which can then be interposed between assembly 21 and ledge 26.

Referring again to FIG. 1, clapper and valve seat assembly 21 includes a clapper assembly 22 and a valve seat 24. Clapper assembly 22 includes a base member, such as a plate 34, with a pair of projecting brackets 36 and 38, which pivotally mount clapper assembly 22 to valve seat 24. Base member 34 and brackets 36 and 38 are typically metal, but may also be formed from plastic or a resin, such as described in reference to valve seat 24 below. Brackets 36 and 38, therefore, may be welded to, glued to, or otherwise integrally formed, such as by molding, with base member 34. Clapper assembly 22 further includes a resilient member 40, which is mounted to plate 34 by retainer 42 and a bolt 44a and nut 44b. Bolt 44a extends through a central opening 34a of plate 34, a central opening 40a of resilient member 40, and a central opening 42a of retainer 42 for engagement by nut 44b to thereby form a unitary clapper assembly. In addition, clapper assembly 22 includes a washer 44c, typically a rubber bonded metallic washer, between bolt 44a and plate 34 that seals against plate 34 at the center opening of plate 34 to prevent flow in both directions. In the illustrated embodiment, plate 34 is circular with a central opening, and with resilient member 40 and retainer 42 having annular shapes.

Valve seat 24 comprises a valve seat body 46, preferably an annular body, with a pair of flanges 48 and 50 that are interconnected by a transverse member 52. Flanges 48 and 50 may be welded to, glued to, or integrally formed with seat body 46. Flanges 48 and 50 each include a mounting opening 48a, 50a for receiving a hinge pin 54 for pivotally mounting clapper assembly 22 to valve seat 24. Pin 54 is held in place in openings 48a, 50a with limited axial movement through openings 48a and 50a due to close engagement with the valve body. Mounted about hinge pin 54 is a spring 56, such as a torsion spring, with one end 56a for extending over clapper assembly 22, as best seen in FIGS. 3 and 4, and a second end 56b, which bears against transverse member 52. In this manner, when hinge pin 54 is extended through the openings 36a and 38a of brackets 36 and 38 of clapper assembly 22, spring 56 will bias clapper assembly 22 downward to a closed position on valve seat 46 to thereby close the valve. Consequently, clapper and valve seat assembly 21 provides a one-way closure device that prevents flow of fluid in one direction only. Spring 56 is preferably sized to limit, if not prevent, water hammer and leaks at low pressure and, further, allow for horizontal installation. Further, the alignment of resilient member 40 on the seat is, therefore, independent of the valve body (12). In addition, as will be more fully described below, because the torsion spring is held in place by three holders—that is the hinge pin, the clapper assembly, and the valve seat—the spring torque will not generate significant loads on the seal interface, for example on the epoxy seal noted below, between the valve seat and valve body.

Optionally, valve seat body 46 may be formed from a plastic or resin material, such as a phenolic material, and, further, may be reinforced with fibers, including graphite fibers, bronze fibers, glass fibers or the like. In addition, valve seat body 46 may be adhesively bonded to valve body 12 to provide a seal in lieu of, or in addition, to seal 30. For example, valve seat body 46 may have an epoxy seal provided between valve seat body 46 and body 12 at or adjacent ledge 26. As with seal 30, the epoxy seal creates a seal that prevents flow in both directions and, further, can be used to secure seat 24 in its intended position.

In addition to facilitating an adhesive bond to body 12, the non-metallic material forming valve seat 24 enables the seat to be molded to the finished shape of valve body 12. Further, valve seat body 46 may be configured to form a snap-fit connection with valve body 12. This connection can then be supplemented with an epoxy seal to provide a secondary method of connecting the valve seat to valve body 12.

In addition, valve seat body 46 may be provided with or formed with one or more seal receiving surfaces 46a, 46b (see FIG. 4), for example to accommodate seal 30, or to accommodate the epoxy seal.

Referring to FIG. 4, outlet 16 is sized to permit clapper and valve seat assembly 21 to be inserted into valve body 12 through outlet 16. As would be understood, when clapper assembly 22 is mounted to valve seat 24 and inserted into body 12 and seated on ledge 26, clapper and valve seat assembly 21 divides valve body 12 into two chambers when plate 34 and resilient member 40 are urged downwardly towards seat 24 by spring 56. As would be understood, plate 34 and member 40 are sized to extend over the upper open end 24a of seat 24 to thereby seal against seat 24 and, thereby, close the fluid communication between inlet 18 and outlet 16 through fluid passageway 14.

In addition, as best seen in FIG. 4, resilient member 40 comprises a generally flat-shaped annular resilient disc with a central annular rib 60 that extends around opening 40a facing away from plate 34. Similarly, retainer 42 comprises an annular member with a central raised central portion 62, which includes central opening 42a and, which extends through said central opening 40a of annular member 40 and rests against the underside 34b of plate 34 when retainer 42 is secured to plate 34. In addition, retainer 42 includes an outwardly extending annular flange 63, which includes an annular recess or groove 64 that aligns with annular rib 60 so that when retainer 42 is mounted to plate 34, retainer 42 will interlock with member 40 and securely mount annular member 40 to plate 34. In addition, recess 64 will properly align annular member 40 with respect to plate 34.

Referring again to FIG. 1, brackets 36 and 38 of clapper assembly 22 include openings 36a and 38a, which are optionally elongated. When elongated, openings 36a and 38a are dimensioned to allow the clapper assembly to vertically align with the valve seat but maintain the horizontal alignment of the clapper relative to the seat. Further, because clapper assembly 22 and valve seat 24 may be preassembled as a unit prior to installation, the alignment of resilient member 40, which provides a seal, is independent of the valve body 12. As would be understood from the description herein, the combination of the brackets 36 and 38 and the flanges 48 and 50 create an alignment of the elastomer seal to the seat about all axes and in all planes.

Referring to FIGS. 5A, 5B, and 6-8, the numeral 110 generally designates another embodiment of the check valve of the present invention. Similar to valve 10, check valve 110 includes a valve body 112 with a clapper and valve seat assembly 121 with a clapper assembly 122 and a valve seat 124. For further general details of valve seat 124 and its mounting in body valve 112, reference is made to the first embodiment.

In the illustrated embodiment, clapper assembly 122 is formed from an encapsulated circular plate or disc 134 (FIGS. 7 and 8). Disc 134 is encapsulated in a resilient body 140 formed from a resilient material, such as a rubber material, so that both of its facing sides 134b and 135c, as well as its perimeter, are encased in a resilient material to thereby form an integral sealing surface on clapper assembly 122. Clapper assembly 122 similarly includes a pair of bushings 136 and 138 (FIG. 5), which are secured to or otherwise formed with disc plate or disc 134, for example by encapsulation. Clapper assembly 122 is similarly pivotally mounted to seat 124 by a hinge pin 154 that extends through brackets 148 and 150 of annular seat 124 and, further, is biased in its closed position by a torsion spring 156 that is mounted about hinge pin 154. Spring 156 includes a first portion, such as end 156a, that extends over the top of clapper assembly 122 (as best seen in FIG. 8), and a second portion, such as end 156b, which in the illustrated embodiment, is extended upwardly to bear against the inner surface of body 112 to thereby bias the clapper assembly 122 in its closed position. Optionally, end 156b may be positioned to apply its spring force against valve seat 124 similar to the previous embodiment.

In the illustrated embodiment, brackets 148 and 150 of valve seat 124 incorporate a pair of C-shaped openings 148a and 150a. Hinge pin 154 is mounted in openings 148a and 150a and held therein by retaining clips 170 and 172. Retaining clips 170 and 172 engage brackets 148 and 150, which secure hinge pin 154 within the generally C-shaped openings. Clips 170 and 172 are of similar construction and mount in a groove 154a formed in hinge pin 154 and include a pair of protecting arms 170a and 170b (172a, 172b) to engage the upper and side edges of the respective flanges 148 and 150 of seat 124, which facilitates separate removal of clapper assembly 122 from the valve seat. In addition, seat body 124 preferably includes elongate openings in brackets 148 and 150 to allow the clapper assembly to vertically align with the valve seat while maintaining the horizontal alignment of the clapper assembly relative to the seat.

Optionally, as described in reference to the previous embodiment, valve seat 124 may be secured in place within cast body 112 for example, by an adhesive, such as an epoxy, in addition to, or in place of, an o-ring seal for sealing the valve seat to the cast body, to increase the leakage resistance of the clapper and valve seat.

Accordingly, the present invention provides a clapper and valve seat assembly for a check valve that allows the several components to be removed for replacement or repair. In addition, when the valve seat and/or the clapper are assembled from plastic or resin components, the weight of the clapper and valve seat assembly may be significantly reduced over corresponding cast components. As a result, the valve weight is reduced and is easier to handle. In addition, the cost of the valve is reduced. Given the cost of labor, in some instances it may be advantageous to replace the whole valve rather than repair or replace its component parts.

While several forms of the invention have been shown and described, other forms will now be apparent to those skilled in the art. Therefore, it will be understood that the embodiments shown in the drawings and described above are merely for illustrative purposes, and are not intended to limit the scope of the invention which is defined by the claims which follow as interpreted under the principles of patent law including the doctrine of equivalents.

We claim:

1. A check valve comprising:
a valve body having a passageway therethrough;
a valve seat positioned in said valve body in said passageway dividing said passageway into two chambers, said valve seat having a valve seat body and an opening through said valve seat body;
a clapper assembly pivotally mounted to said valve seat by a hinge pin and biased to close said opening of said valve seat body to thereby block the flow of fluid through said passageway; and
wherein said hinge pin is captured between portions of said valve body to thereby retain said clapper assembly at said valve seat.

2. The check valve according to claim 1, wherein said clapper assembly includes a base member with at least one resilient face for sealing against said valve seat.

3. The check valve according to claim 2, wherein said base member is at least partially encapsulated with a resilient material, said resilient material forming said at least one resilient face.

4. The check valve according to claim 1, wherein said clapper assembly or said valve seat includes a pair of elongate openings, said hinge pin extending through said elongate openings and pivotally mounting said clapper assembly to said valve seat, said elongated openings allowing adjustment of said clapper assembly with respect to said valve seat in one direction and limiting movement of said clapper with respect to said valve seat in another direction.

5. The check valve according to claim 1, wherein said valve seat body comprises a plastic or resin material.

6. The check valve according to claim 5, wherein said valve seat body is adhesively bonded to said valve body to thereby seal said valve seat in said passageway.

7. The check valve according to claim 1, wherein said valve seat body is sealed in said passageway of said valve body by a seal.

8. The check valve according to claim 1, wherein said valve seat includes a pair of flanges, said clapper assembly pivotally mounted to said flanges to thereby pivotally mount said clapper assembly to said valve seat.

9. The check valve according to claim 8, further comprising a spring, said spring biasing said clapper assembly to said closed position, said spring applying a spring force to said clapper assembly and applying a spring force to valve body or said valve seat.

10. The check valve according to claim 9, wherein said spring includes a first end applying a spring force to said clapper assembly and a second end applying a spring force to said valve seat.

11. The check valve according to claim 10, wherein said flanges of said valve seat are interconnected by a transverse member, said second end applying a spring force to said transverse member.

12. A check valve comprising:
a valve body having a passageway therethrough;
a valve seat positioned in said valve body in said passageway dividing said passageway into two chambers, said valve seat having a valve seat body and an opening through said valve seat body, said valve seat including a pair of flanges, said flanges interconnected by a transverse member; and
a clapper assembly pivotally mounted to said valve seat by a hinge pin, said hinge pin including a torsion spring biasing said clapper assembly to close said opening of said valve seat body to thereby block the flow of fluid through said passageway, and said spring applying a spring force against said clapper assembly and applying a spring force against said valve seat.

13. The check valve according to claim 12, wherein said spring applies said spring force against said valve seat at said transverse member.

14. The check valve according to claim 13, wherein said spring includes one end applying said force against said clapper assembly, said spring including another end applying said spring force against said transverse member.

15. The check valve according to claim 12, wherein said clapper assembly includes a base member, with at least one resilient face for sealing against said valve seat.

16. The check valve according to claim 15, wherein said base member is at least partially encapsulated with a resilient material, said resilient material forming said at least one resilient face.

17. The check valve according to claim 12, wherein said clapper assembly includes a pair of brackets, each of said brackets including an elongate opening, said hinge pin extending through said elongate openings to thereby pivotally mount said clapper assembly to said valve seat, said elongated openings allowing adjustment of said clapper assembly with respect to said valve seat in one direction and limiting movement of said clapper with respect to said valve seat in another direction.

18. The check valve according to claim 12, wherein said valve seat includes at least a surface for an elastomeric seal or a surface for an epoxy seal.

19. The check valve according to claim 12, wherein said valve seat includes at a surface for an epoxy seal with said valve body.

20. The check valve according to claim 12, wherein said valve seat includes a snap fit connection with said valve body.

21. The check valve according to claim 20, wherein said valve seat further includes an epoxy seal with said valve body.

22. A check valve comprising:
a valve body having a passageway therethrough, said passageway forming an inlet and an outlet for said valve body;
a clapper and valve seat assembly positioned in said valve body in said passageway dividing said passageway into two chambers, said clapper and valve seat assembly having a valve seat body and a clapper assembly pivotally mounted to said valve seat body by a hinge pin, said clapper assembly being biased in a closed position to seal against said valve seat to thereby block the flow of fluid through said passageway; and
said outlet of said valve body being dimensioned to permit said clapper and valve seat assembly to be inserted through said outlet for installation in said valve body.

23. The check valve according to claim 22, wherein said clapper assembly includes a base member, with at least one resilient face for sealing against said valve seat.

24. The check valve according to claim 23, wherein said base member is at least partially encapsulated with a resilient material, said resilient material forming said at least one resilient face.

25. The check valve according to claim 22, wherein said valve seat body comprises a plastic or resin material.

26. The check valve according to claim 25, wherein said valve seat body is adhesively bonded to said valve body to thereby seal said valve seat in said passageway.

27. The check valve according to claim 25, wherein said valve seat includes a pair of flanges, said clapper assembly pivotally mounted to said flanges to thereby pivotally mount said clapper assembly to said valve seat.

28. The check valve according to claim 22, further comprising a spring, said spring biasing said clapper assembly to said closed position, said spring applying a spring force to said clapper assembly and applying a spring force to valve body or said valve seat.

29. The check valve according to claim 28, wherein said spring includes a first end applying the spring force to said clapper assembly and a second end applying the spring force to said valve seat.

30. The check valve according to claim 29, wherein said flanges of said valve seat are interconnected by a transverse member, said second end applying the spring force to said transverse member.

31. The check valve according to claim 22, wherein said valve seat includes at a surface for an epoxy seal with said valve body.

32. A check valve comprising:
a valve body having a passageway therethrough;
a valve seat positioned in said valve body in said passageway dividing said passageway into two chambers, said valve seat having a valve seat body and an opening through said valve seat body;
a clapper assembly pivotally mounted to said valve seat by a hinge pin and biased to close said opening of said valve seat body to thereby block the flow of fluid through said passageway; and
said clapper assembly comprising:
a base member;
a resilient member having a rib; and
a retainer securing said resilient member to said base member, said retainer having a recess for receiving said rib of said resilient member to thereby interlock said resilient member to said retainer to secure said resilient member to said base member.

33. The check valve according to claim 32, wherein said base member comprises a plate.

34. The check valve according to claim 32, wherein said rib comprises an annular rib.

35. The check valve according to claim 32, wherein said resilient member comprises an annular resilient member.

36. The check valve according to claim 32, wherein said clapper assembly includes a pair of brackets, each of said brackets including an elongate opening, said hinge pin extending through said elongate openings to thereby pivotally mount said clapper assembly to said valve seat, said elongated openings allowing adjustment of said clapper assembly with respect to said valve seat in one direction and limiting movement of said clapper with respect to said valve seat in another direction.

37. The check valve according to claim 32, further comprising a spring, said spring biasing said clapper assembly to said closed position, said spring applying a spring force to said clapper assembly and applying a spring force to valve body or said valve seat.

38. The check valve according to claim 37, wherein said spring applies a spring force to said valve seat.
